(19) United States
(12) Patent Application Publication
(10) Pub. No.: US 2023/0191428 A1
(43) Pub. Date: Jun. 22, 2023

(54) Fixed Cylinder Centrifuge

(71) Applicant: Chengdu Fushunqi Energy Saving and Environmental Protection Technology Co., Ltd., Pengzhou (CN)

(72) Inventors: Qi Shen, Pengzhou (CN); Mingxian Shen, Pengzhou (CN); Xiuping Yang, Pengzhou (CN); Changzheng Sun, Pengzhou (CN); Xuyun Kong, Pengzhou (CN)

(73) Assignee: Chengdu Fushunqi Energy Saving and Environmental Protection Technology Co., Ltd., Pengzhou (CN)

(21) Appl. No.: 17/555,215

(22) Filed: Dec. 17, 2021

(51) Int. Cl. B04B 1/20; B04B 11/02

(52) U.S. Cl. CPC B04B 1/2016; B04B 11/02; B04B 2001/2091; B04B 2001/2083

(57) ABSTRACT

The present disclosure provides a fixed cylinder centrifuge, including a base, a driving device, a screw propeller, a liquid inlet pipe, and a fixed cylinder. The fixed cylinder includes a straight cylinder and a conical cylinder. The straight cylinder and the conical cylinder are communicated with each other and are connected to each other through a first flange. Sand discharging holes are formed in the tail end of the conical cylinder. The screw propeller is rotatabh arranged in the straight cylinder and the conical cylinder and includes a central pipe and a blade. The blade is spirally welded on a pipe wall of the central pipe in an axial direction. A tiny spacing is reserved between the tail end of the blade and the inner wall of the straight cylinder and between the tail end of the blade and the inner wall of the conical cylinder.

### TECHNICAL FIELD

The present disclosure relates to the technical field of centrifuges, and in particular, to a fixed cylinder centrifuge.

### BACKGROUND

A centrifuge is a mechanical device that separates liquid from solid particles by using a centrifugal force. Horizontal centrifuge structures are common. This centrifuge is mainly composed of a high-speed rotary cylinder, a screw conveyor which has the same rotating direction as the rotary cylinder, slightly lower rotating speed than that of the rotary cylinder, and a hollow rotating shaft, a differential mechanism, and the like. When a suspension liquid to be separated is fed into the rotary cylinder through the hollow rotating shaft, it is thrown into a cavity of the rotary cylinder under the action of the centrifugal force generated by high-speed rotation. Due to different densities, liquid and solid particles will be pushed into two different areas slowly, and finally, separation is realized.

At present, the common horizontal screw centrifuge drives the rotary cylinder by using a main motor, drives a screw propeller by using an auxiliary motor, and realizes solid-liquid separation through the differential speed of the rotary cylinder and the screw propeller. However, two sets of motors need to be driven by using such methods, which will consume a large amount of electrical energy. Meanwhile, since the rotary cylinder and the propeller need to perform relative movement, the differential mechanism needs to be arranged, and the manufacturing cost is relatively high. In addition, such structures are prone to a machine holding phenomenon.

Therefore, the present application provides a new fixed cylinder centrifuge.

### BRIEF DESCRIPTION OF THE DRAWINGS

These drawings illustrate certain aspects of some examples of the present disclosure and should not be used to limit or define the invention.

FIG. 1 is a front view of a fixed cylinder centrifuge of an embodiment of the present disclosure; and

FIG. 2 is a stereogram of an interior of the fixed cylinder centrifuge of the embodiment of the present disclosure.

### DETAILED DESCRIPTION

In order to solve the abovementioned problem, an objective of the present disclosure is to provide a fixed cylinder centrifuge. The device drives a screw propeller to realize solid-liquid separation by using a single motor, which can effectively reduce the energy consumption and the equipment manufacturing cost.

To achieve the abovementioned objective, the present disclosure provides the following technical solution.

A fixed cylinder centrifuge includes a base, a driving device, a screw propeller, a liquid inlet pipe, and a fixed cylinder. The fixed cylinder includes a straight cylinder and a conical cylinder. The straight cylinder and the conical cylinder are communicated with each other and are connected to each other through a first flange. Two rows of sand discharging holes are formed in the tail end of the conical cylinder.

A box body is erected at a bottom of an outer side of the straight cylinder and the conical cylinder, and a box cover is arranged at a top of the outer side. The box body is erected on the base. The box cover is hinged to the box body.

The screw propeller is rotatably arranged in the straight cylinder and the conical cylinder and includes a central pipe and a blade. The blade is spirally welded on an excircle of the central pipe in an axial direction. A tiny spacing is reserved between the tail end of the blade and the inner wall of the straight cylinder and between the tail end of the blade and the inner wall of the conical cylinder. A plurality of circular holes are formed in a pipe surface of the central pipe. One end of the central pipe penetrates through one side of the box body and is driven to rotate through the driving device.

One end of the liquid inlet pipe penetrates through the other side of the box body, extends into the conical cylinder, and is communicated with the other end of the central pipe.

An overflow plate is fixedly arranged at the other end of the straight cylinder. A plurality of overflow ports are formed in a plate surface of the overflow plate. A slurry discharging port and a sand discharging port corresponding to the overflow plate and the sand discharging holes are formed in the bottom of the box body.

Preferably, one end of the central pipe is fixedly connected to a connecting shaft. The connecting shaft is erected on the base through a bearing seat.

Preferably, the driving device includes a motor, a hydraulic coupler, a belt, and two belt pulleys. The motor is erected on the base through a motor seat. The motor drives one of the belt pulleys to rotate. The belt pulley is in transmission connection with the hydraulic coupler. The two belt pulleys are driven through the belt. The other of the belt pulleys is in transmission connection with the central pipe of the screw propeller through a rotating shaft.

Preferably, the other end of the liquid inlet pipe is erected on the base through a fixed seat.

Preferably, the overflow plate is connected to the other end of the straight cylinder through a second flange.

The present disclosure has the beneficial effects that: the present disclosure provides a fixed cylinder centrifuge. Since the outer cylinder is fixed, only one motor is needed to drive the screw propeller, which saves more than 60% energy than a horizontal screw centrifuge driven by two motors.

Since there is no need for differential rotational speed for relative movement between the fixed cylinder and the screw propeller, there is no need for a differential mechanism in the structure, and a main motor is reduced, thereby saving the manufacturing cost.

The fixed cylinder centrifuge is easy to operate and maintain during use and does not cause a machine holding phenomenon with the screw propeller during operating, so the use efficiency is greatly improved.

Centrifuges are widely used in the industries, such as oil drilling, oil storage and transportation, sewage treatment, and chemical industry. If tens of thousands of centrifuges currently used in China are structurally transformed into fixed cylinder centrifuges in the future, which will save a large amount of energy and create good economic benefits.

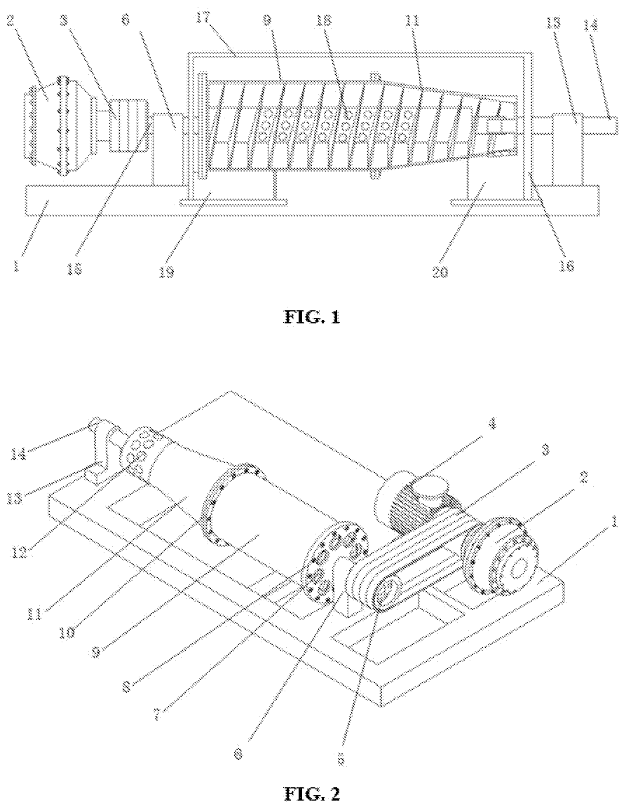

FIGS. 1 and 2 illustrate a fixed cylinder centrifuge of an embodiment of the present disclosure. A fixed cylinder centrifuge includes a base 1, a driving device, a screw propeller 18, a liquid inlet pipe 14, and a fixed cylinder. The fixed cylinder includes a straight cylinder 9 and a conical cylinder 11. The straight cylinder 9 and the conical cylinder 11 are communicated with each other and are connected to each other through a first flange 10. Two rows of sand discharging holes 12 are formed in the tail end of the conical cylinder 11.

A box body 16 is erected at a bottom of an outer side of the straight cylinder 9 and the conical cylinder 11, and a box cover 17 is arranged at a top of the outer side and is used for dividing a flow and protecting after solid-liquid separation. The box body 16 is erected on the base 1, and the box cover 17 is hinged to the box body 16, so as to facilitate detaching and cleaning.

The screw propeller is rotatably arranged in the straight cylinder 9 and the conical cylinder 11 and includes a central pipe and a blade. The blade is spirally welded on an excircle of the central pipe in an axial direction. A tiny spacing is reserved between the tail end of the blade and the inner wall of the straight cylinder 9 and between the tail end of the blade and the inner wall of the conical cylinder 11, which facilitates screw propelling and accelerates solid-liquid separation. A plurality of circular holes are formed in a pipe surface of the central pipe. One end of the central pipe penetrates through one side of the box body 16 and is driven to rotate through the driving device.

The liquid inlet pipe 14 penetrates through the box body 16 and the conical cylinder 11 in sequence and is communicated with the other end of the central pipe.

An overflow plate 7 is fixedly arranged at the other end of the straight cylinder 9. A plurality of overflow ports are formed in a plate surface of the overflow plate 7. A slurry discharging port 19 and a sand discharging port 20 corresponding to the overflow plate 7 and the sand discharging holes 12 are formed in the bottom of the box body 16, and solid and liquid are discharged through the slurry discharging port 19 and the sand discharging port 20.

Preferably, one end of the central pipe is fixedly connected to a connecting shaft 15. The connecting shaft 15 is erected on the base 1 through a bearing seat 6.

Further, the driving device includes a motor 4, a hydraulic coupler 2, a belt 3, and two belt pulleys 5. The motor 4 is erected on the base 1 through a motor seat. The motor 4 drives one of the belt pulleys 5 to rotate. The belt pulley 5 is in transmission connection with the hydraulic coupler 2. The two belt pulleys 5 are driven through the belt 3. The other of the belt pulleys 5 is in transmission connection with the central pipe of the screw propeller 18 through a rotating shaft. The screw propeller 18 is driven to rotate by synchronous drive to realize the solid-liquid separation.

In addition, the liquid inlet pipe 14 is erected on the base 1 through a fixed seat 13.

In addition, the overflow plate 7 is connected to the other end of the straight cylinder 9 through a second flange 8, so as to facilitate mounting and detaching of the overflow plate 7 and the straight cylinder 9.

In the present embodiment, liquid slurry is fed into the central pipe of the screw propeller 18 through the liquid inlet pipe 14. The motor 4 is controlled to rotate, so as to drive the screw propeller 18 to rotate. Since the plurality of circular holes are formed in a pipe surface of the central pipe, the liquid slurry is sprayed on the inner wall of the fixed cylinder the circular holes, at this time, due to the rotating screw propeller 18, a solid phase part is remained on the inner wall, and a liquid phase part is discharged from the overflow ports at a large end of the straight cylinder 9 after being separated, and finally, is discharged from the slurry discharging port 19 at the bottom.

Solid particles on the inner walls of the straight cylinder 9 and the conical cylinder 11 are scrapped off through the operation of the blade of the screw propeller 18, then are discharged from the sand discharging holes, and finally, are discharged from the sand discharging port 20 at the bottom, thereby realizing the solid-liquid separation.

In the present embodiment, since the outer cylinder is fixed, the screw propeller needs to be driven by only one motor, which saves more than 60% energy than the currently used horizontal screw centrifuge driven by two motors.

The minimum power required for driving by using two sets of motors is: 55+22=77 KW. The power required for driving by using one set of motor is: 30 KW. The ratio is: 30/77=0.3896.

The abovementioned calculation results show that the screw propeller driving by using only one motor provided by the present disclosure can save a large amount of energy and reduce the production cost.

The above is merely preferred embodiments of the present disclosure and is not intended to limit the present disclosure. Any modifications, equivalent replacements, improvements and the like made within the spirit and principle of the present disclosure shall fall within the scope of protection of the present disclosure.

What is claimed is:

1. A fixed cylinder centrifuge comprising:
a base;
a driving device;
a screw propeller;
a liquid inlet pipe;
a fixed cylinder, wherein the fixed cylinder comprises a straight cylinder and a conical cylinder, wherein the straight cylinder and the conical cylinder are communicated with each other and are connected to each other through a first flange, wherein two rows of sand discharging holes are formed in the tail end of the conical cylinder;
a box body erected at a bottom of an outer side of the straight cylinder and wherein the conical cylinder and a box cover are arranged at a top of the outer side, the box body erected on the base, wherein the box cover is hinged to the box body;
wherein the screw propeller is rotatably arranged in the straight cylinder and the conical cylinder, and comprises a central pipe and a blade, wherein the blade is spirally welded on an excircle of the central pipe in an axial direction;
a spacing between the tail end of the blade and the inner wall of the straight cylinder and between the tail end of the blade and the inner wall of the conical cylinder;
a plurality of circular holes formed in a pipe surface of the central pipe, wherein one end of the central pipe penetrates through one side of the box body, and is driven to rotate through the driving device;
wherein one end of the liquid inlet pipe penetrates through the other side of the box body, extends into the conical cylinder, and is communicated with the other end of the central pipe;
an overflow plate fixedly arranged at the other end of the straight cylinder;
a plurality of overflow ports formed in a plate surface of the overflow plate; and
a slurry discharging port and a sand discharging port corresponding to the overflow plate, the sand discharging holes formed in the bottom of the box body.

2. The fixed cylinder centrifuge of claim 1, wherein one end of the central pipe is fixedly connected to a connecting shaft, and the connecting shaft is erected on the base through a bearing seat.

3. The fixed cylinder centrifuge of claim 2, wherein the driving device comprises a motor, a hydraulic coupler, a belt, and two belt pulleys; the motor is erected on the base through a motor seat; the motor drives one of the belt pulleys to rotate; the belt pulley is in transmission connection with the hydraulic coupler; the two belt pulleys are driven through the belt; and the other of the belt pulleys is in transmission connection with the central pipe of the screw propeller through a rotating shaft.

4. The fixed cylinder centrifuge of claim 1, wherein the other end of the liquid inlet pipe is erected on the base through a fixed seat.

5. The fixed cylinder centrifuge of claim 1, wherein the overflow plate is connected to the other end of the straight cylinder through a second flange.
